(19) United States
(12) Patent Application Publication
(10) Pub. No.: US 2016/0104078 A1
(43) Pub. Date: Apr. 14, 2016

(54) SYSTEM AND METHOD FOR GENERATING EVENT LISTINGS WITH AN ASSOCIATED VIDEO PLAYLIST

(71) Applicants: Tim Carlo Jörges, Zurich (CH); Christoph Renner, Rotkreuz (CH); Alexander Taboriskiy, Zurich (CH); Ted Hamilton, Kusnacht (CH)

(72) Inventors: Tim Carlo Jörges, Zurich (CH); Christoph Renner, Rotkreuz (CH); Alexander Taboriskiy, Zurich (CH); Ted Hamilton, Kusnacht (CH)

(21) Appl. No.: 13/469,786

(22) Filed: May 11, 2012

(51) Int. Cl. G06Q 10/02; G06F 17/30; H04L 29/08; G06F 3/0482

(52) U.S. Cl. CPC G06Q 10/02; G06F 3/0482; G06F 17/30053; H04L 67/306; H04L 67/18

(57) ABSTRACT

Providing media relating to an event ticket marketplace is described. A method to provide media related to an event list can include maintaining or identifying a user profile and associating the user profile with a request of the user to access an event ticket marketplace. The method can include determining an event list including information associated with one or more events based on the user profile, which may include, for example, a media consumption history and current location, as permitted by the user. The method can include determining a media playlist including one or more media files (e.g., videos) associated with the identified events. A media file from the media playlist is selected, and a graphical user interface (GUI) is generated and presented which includes the event list, the playlist and the selected media file.

### TECHNICAL FIELD

Embodiments of the present invention relate to the field of video and audio delivery services and, more particularly, to an event ticket marketplace including a related video and/or audio presentation.

### BACKGROUND

On the Internet, event ticket websites and applications allow users to search, view, and purchase tickets to an event. Such event ticket websites and applications typically allow the user to search for event information based on a location or geographic area (e.g., a zip code) and/or a date or event time frame. In identifying one or more events of interest, the user is typically provided with basic information regarding the event, such as, for example, the artist's name, venue information, and basic event information (e.g., date and time of the event). In some instances, a Uniform Resource Locator (URL) link to separate websites associated with the artist or the event is provided which the user can select in order to obtain more information about the artist or event.

Many ticket brokering websites and applications provide potential event and ticket customers with suggested event listings to advertise various events to different users. However, the suggested event listings are usually based solely on preferences that the user manually enters and maintains.

### SUMMARY

In one embodiment, a method to facilitate an event ticket marketplace including event listings and associated media content identified based on a user's profile is provided. The method includes maintaining or identifying a user profile and associating the user profile with a request from the user to access the event ticket marketplace website or application (herein referred to as the “event ticket marketplace”). Alternatively, the request may be processed without associating it with a user profile by utilizing information, parameters, and/or constraints communicated by the user via a user interface. The method then determines an event list including information associated with one or more events based on the user profile, information, parameters, and/or constraints. The method also determines a media playlist including one or more media files (e.g., videos) associated with the identified events. A media file from the media playlist is selected, and a graphical user interface (GUI) is provided which includes the event list, the playlist and the selected media file.

In another embodiment of the invention, another method to provide an event ticket marketplace including event listings and associated media content identified based on a user's media consumption history is presented. The method includes maintaining a media consumption history associated with a user and associating the media consumption history with a request from the user to access the event ticket marketplace. The method then determines an event list including information associated with one or more events based on the media consumption history. The method also determines a media playlist including one or more media files (e.g., videos) associated with the identified events. A media file from the media playlist is selected, and a graphical user interface (GUI) is provided which includes the event list, the playlist and the selected media file.

In additional embodiments, computing devices for performing the operations of the above described embodiments are also implemented. Additionally, in embodiments of the invention, a computer readable storage media stores methods for performing the operations of the above described embodiments.

### BRIEF DESCRIPTION OF THE DRAWINGS

The present invention will be understood more fully from the detailed description given below and from the accompanying drawings of various embodiments of the invention.

FIG. 1 illustrates an exemplary system architecture, in accordance with one embodiment of the present invention.

FIG. 2 illustrates a flow diagram of one embodiment of a method for providing an event ticket marketplace, in accordance with one embodiment of the present invention.

FIG. 3 illustrates an exemplary GUI generated in accordance with the method of FIG. 2, in accordance with one embodiment of the present invention.

FIGS. 4A and 4B depict exemplary screenshots of an event ticket marketplace, in accordance with one embodiment of the present invention.

FIG. 5 is a block diagram of an exemplary computer system that may perform one or more of the operations described herein.

### DETAILED DESCRIPTION

A system and method for a web-based event ticket marketplace including event listings and associated media content customized for a user are described. Embodiments of the invention maintain a user profile and associate the user profile with a request from the user to access an event ticket marketplace. Based on the user profile, an event list including information associated with one or more events is determined. In another embodiment, the request may be processed without associating it with a user profile. In this embodiment, the event list may be determined based on information, parameters, and/or constraints specified by the user via a user interface. A media playlist, including one or more media files (e.g., videos) associated with the identified events, is also determined. In addition, a media file from the media playlist is selected for playback to the user. In response to the request to access the event ticket marketplace, a graphical user interface (GUI) is generated which presents the user with the event list, the playlist, and the selected media file.

In one embodiment, the event list is determined based on a media consumption history associated with a user. As used herein, the media consumption history may include, but is not limited to, a user's previous video viewing history, the user's previous audio listening history, and/or information relating to the user's interactions with the previously played video and/or audio files. In one embodiment, the selected media file is determined based on the media consumption history. In one embodiment, the user is provided with the opportunity to opt-out of having all or some of his/her consumption history stored and/or accessed by a server, e.g., a server of the event ticket marketplace.

In one embodiment, the selected media file is automatically streamed or played back in a media file playback window of the GUI at the time the user accesses the event ticket marketplace, e.g., via a user device such as a laptop, mobile phone, or tablet computer. In one implementation, once the event ticket marketplace is accessed by the user device, the GUI is dynamically generated and the selected media file automatically begins playing in the GUI.

In one embodiment, the GUI presents one or more action buttons or fields to the user, and the user may select the action button to cause the performance of a corresponding action (e.g., a ‘purchase tickets’ action, a ‘more’ or ‘more information’ action, a ‘next act’ or ‘next event’ action). Based on an instruction associated with the user's selection of an action button, the GUI may be updated to include an updated event listing, an updated playlist, and/or an updated selected media file.

Embodiments of the present invention may also receive, identify or otherwise determine a user's actions and/or indications relating to the playlist and/or media file. The user's action may include, for example, pausing, rewinding, adjusting the volume, skipping, repeating, a length of time spent viewing/listening to a media file, inputting a rating/review associated with the media file, etc. In one embodiment, a user-inputted positive indication relating to an event or media file is received and used to update the playlist to include one or more additional media files associated with the event or media file associated with the positive indication. A positive indication may include, for example, any action or feedback received from a user which indicates a positive reaction to an object, such as, for example, the inputting of a positive rating or score, raising of the volume of the playback of a media file, repeating the playback of a media file, the sharing of a link to a media file, etc.

In one embodiment, the GUI may include an event listing window or first area for presenting the event listing, a media playlist window or second area for presenting the media playlist, and a media file playback or third area for presenting the selected media file. In a further embodiment, the GUI may simultaneously present the event listing and corresponding media playlist. In yet another embodiment, the selected media file may be automatically streamed and begin playing immediately upon presentation of the GUI or soon thereafter.

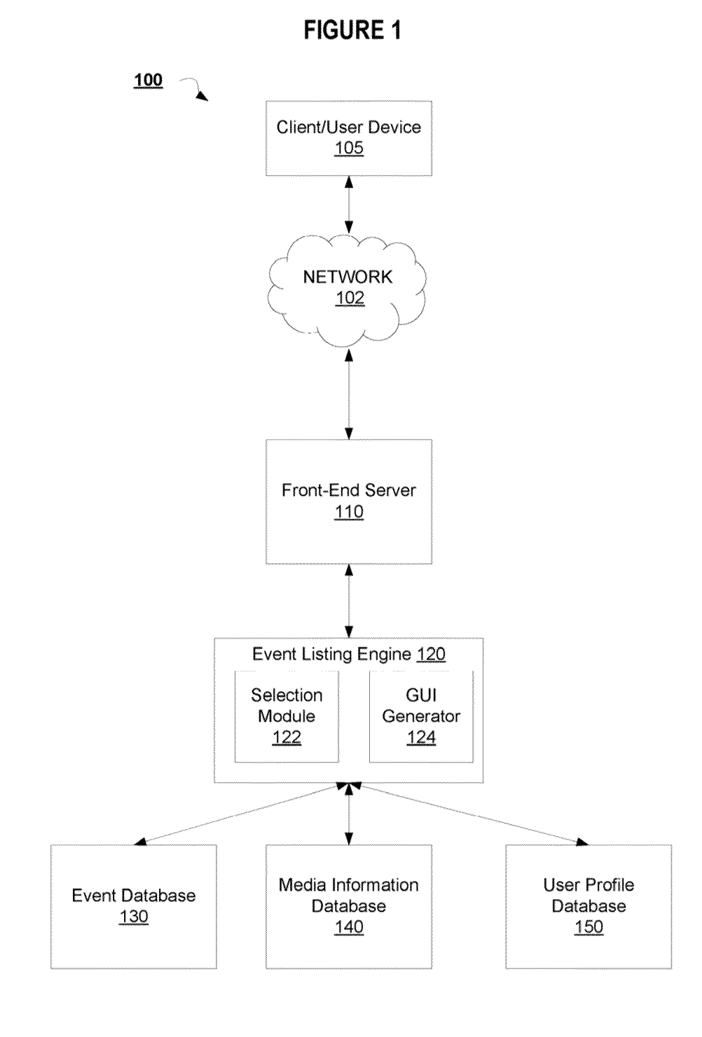

FIG. 1 illustrates an exemplary system architecture 100, in accordance with one embodiment of the present invention. System 100 includes a front-end server 110, an event listing engine 120, an event database 130, a media information database 140, and a user profile database 150. In addition, one or more client/user devices 105 are in communication with the front-end server 110 over a network 102. The network 102 may include the Internet in one embodiment. In other embodiments, other networks, wired and wireless, such as an intranet, local area network (LAN), wide area network (WAN), or broadcast network may be used.

The client/user device 105 may be any type of computing device, for example, a device including a processing device (e.g., a processor), a computer-readable medium, and a memory. In some embodiments, the client/user device 105 may be executing a browser application or other application adapted to communicate over Internet related protocols (e.g., TCP/IP and HTTP) and/or display a user interface. While only a single client/user device 105 is shown in FIG. 1, system 100 may support a large number of concurrent connections and/or sessions with many client/user devices 105.

Moreover, embodiments of the invention may operate within a single server device or on multiple server devices. Although each of front-end server 110, event listing engine 120, event database 130, media information database 140, and user profile database 150 are depicted in FIG. 1 as single, disparate components, these components may be implemented together in a single device or networked in various combinations of multiple different devices that operate together. Examples of devices may include, but are not limited to, servers, mainframe computers, networked computers, process-based devices, and similar type of systems and devices.

During operation of system 100, a user accesses system 100 via client/user device 105 over network 102. The front-end server 110 receives communications from the client/user device 105, and processes and/or directs these communications accordingly. In one embodiment, the front-end server 110 includes a processing device and a computer-readable memory.

Front-end server 110 is configured to present one or more web pages relating to an event ticket marketplace configured to allow one or more users to view event information and purchase tickets to the events. In one embodiment, the front-end server 110 is configured to receive a request from the client/user device 105 for access to the event ticket marketplace and respond to the request by serving a GUI to the client/user device 105, as described in detail below.

Front-end server 110 is communicably coupled to the event listing engine 120. Event listing engine 120 may be implemented in hardware, software, firmware, or any combination of the above. In embodiments of the invention, event listing engine 120 processes the request from a client/user device to access the event ticket marketplace and employs a selection module 122 to maintain or identify a user profile associated with the user stored in the user profile database 150 and associate the user profile with the request. In one embodiment, the selection module 122 of the event listing engine 120 is configured to determine an event list including one or more events for presentation to the user.

In one embodiment, information relating to the event list and associated events is stored in the event database 130. The user profile includes information associated with a user, such as, for example, user preferences and the user's media consumption history as authorized by the user. In an embodiment, the user preferences may be received from a user via a user interface.

In an embodiment, the user preferences can include any user-selected parameters or settings, such as, for example, parameters or settings relating to a preferred location of the event, a preferred location radius, a preferred date range, preferred ticket price limits or ranges, specific taste/interests of the user, a preferred venue size, a preference to exclude previously viewed/previewed events from the event listing, a desired video and/or audio quality, and/or a preferred age range for the event.

In an embodiment, default parameters or settings may be used in cases when the user has not provided his or her preferences. The default parameters and settings may be manually changed or modified by the user. For example, the location of a user may be auto-detected by the system, if so authorized by the user. The auto-detected location of the user may be used as a default location setting for the user and the user is provided with an option to change or modify the default location setting.

Other exemplary default parameters or settings and exemplary user modifications may include a default date range (e.g., next three months) with a user-option to specify a date range, a default location radius (e.g., 50 km) with a user-option to specify a location radius, a default to all available ticket prices with a user-option to specify a ticket price range, a default to all available events with a user-option to filter the events automatically or manually based on music taste/interests, a default to all available venues with a user-option to select or exclude certain venues or filter the venue list based on venue characteristics (e.g., venue size).

The media consumption history may include, for example, a user's previous video viewing history, the user's previous audio listening history, and/or information relating to the user's interactions with the previously played video and/or audio files. Accordingly, as an example, a user's prior viewing on a video sharing website of a particular artist may be taken into account in identifying events of interest near the user's current location. For example, in one implementation, a relatively unknown artist may perform on an entertainment show. The show's producer may then upload the segment to a video sharing website. The user views the segment on the video sharing website and positively rates the video. The user may then search on a mobile device for events near the user's current location. The event listing engine can identify that the user previously viewed the video of the artist, positively rated the video, and that the user's current location is near a venue where the artist has an upcoming performance event. The event listing engine can include the performance event in its listing, thereby providing a customized event listing.

For example, if a user views and positively rates or reviews a video of Band ABC's performance on a late night talk show on a video sharing website, the event listing engine may utilize this information and the user's location to include the Band ABC's upcoming performance at a venue near the user's location in an event listing generated for the user.

In one embodiment, the event ticket marketplace notifies the user of the types of information (e.g., the user profile, media consumption history, user preferences) that are identified, compiled, and/or used by the event listing engine 120 and stored in respective application logs and databases (e.g., the user profile database 150), if any, and provides the user the opportunity to opt-out of having such information stored and/or accessed by the event listing engine 120 and/or the front-end server 110 of the event ticket marketplace.

In one embodiment, the event listing engine 120 is configured to determine and assemble a playlist including one or more media files (e.g., video files and/or audio files) associated with the one or more events of the event list. Following the determination, the event listing engine 120 retrieves information relating to the playlist and the one or more media files from the media information database 140. The media information database 140 is configured to store or have access to the media files and information relating to the media files (which can include e.g., file name, file size, file location, storyboard images, thumbnail images, and the like). In an embodiment, the user may customize, modify or change the playlist. In an embodiment, the playlist may be assembled based at least in part on user profile information (e.g., prior viewing and/or listening habits or history).

In one embodiment, the selection module 122 is further configured to select a media file from the identified playlist for presentation to the user (i.e., playback). In one embodiment, the selection module 122 is configured to select the media file based on the user profile. In another embodiment, the selection module 122 is configured to select the media file based on the user's media consumption history.

In one embodiment, the event listing engine 120 includes a GUI generator 124 configured to generate a GUI including the event listing, the playlist, and the selected media file determined by the selection module 122. In one embodiment, the GUI generator 124 is configured to automatically stream the selected media file in response to the user request. In this embodiment, the GUI generator 124 may present the GUI such that the selected media file is played soon after, e.g., immediately after, an initial web page of the event ticket marketplace is served to the client/user device 105 by the front-end server 110. In another embodiment, the GUI generator 124 is configured to continuously stream multiple media files from the playlist. Although schematically shown in FIG. 1 as two separate modules, the selection module 122 and the GUI generator 124 may be a single module or any number of modules configured to perform the actions and functions of the event listing engine 120 described herein.

In one embodiment, the GUI generator 124 is configured to generate a GUI including an event listing window (for presentation of the event listing), a media playlist window (for presentation of the playlist), and a media file playback window (for presentation of the selected media file). The GUI generator 124 may be configured to generate one or more action buttons or fields that allow the user to perform actions relating to the event ticket marketplace. For example, the GUI generator 124 may be configured to generate action buttons that allow the user to skip through events or, if an event is composed of more than one act, skip through act by act or to manually jump to a new event or act. The GUI generator 124 can also be configured to generate action buttons that allow the user to sort the event list by date, by distance, by ticket price, by relevance to the user's taste, etc.

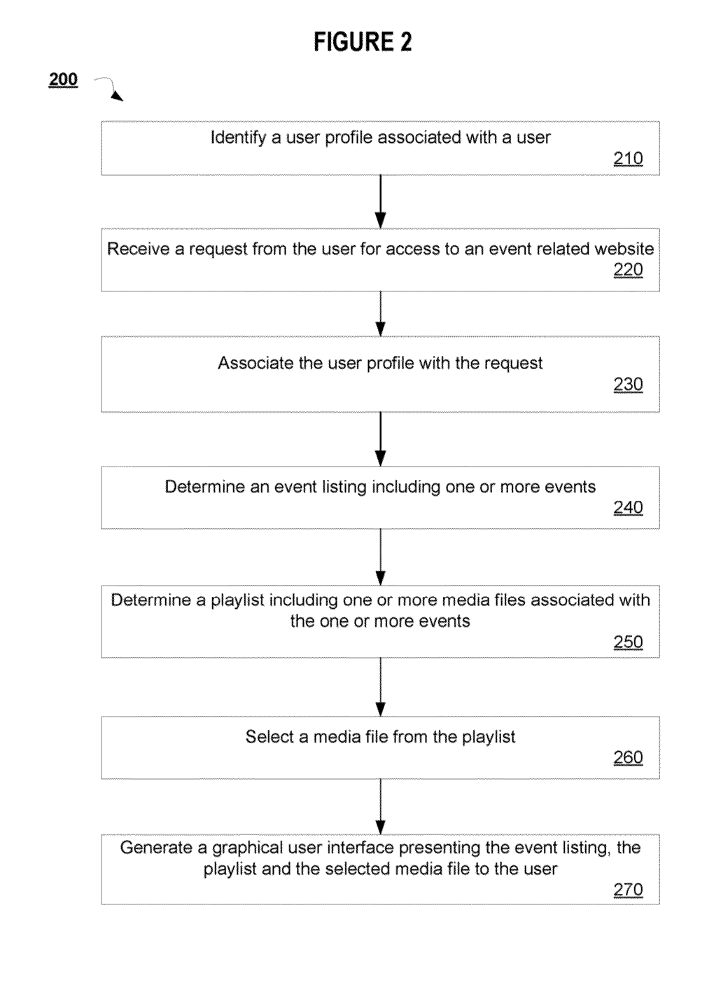

FIG. 2 illustrates a flow diagram of one embodiment of a method for providing an event ticket marketplace. The method is performed by processing logic that may include hardware (circuitry, dedicated logic, etc.), software (such as is run on a general purpose computer system or a dedicated machine), or a combination of both. In one embodiment, the method illustrated in FIG. 2 may be performed by the event listing engine 120 running on a server machine or another machine as described with respect to FIG. 1. More specifically, in one embodiment, method 200 may be performed by the selection module 122 and the GUI generator 124 of the event listing engine 120 of FIG. 1.

At block 210 of method 200, event listing engine identifies a user profile associated with a user. The user profile may be stored in a database, such as, for example, the user profile database 150 of FIG. 1. Advantageously, multiple user profiles associated with multiple users may be maintained in the database and utilized in method 200. In one embodiment, the user profile may include the media consumption history of the user (i.e., previous video viewing history and/or audio listening history). One having ordinary skill in the art will appreciate that the user profile may be maintained in the user profile database 150 independently of the event ticket marketplace.

In block 220, the event listing engine receives a user request for access to the event ticket marketplace. In one embodiment, the user request may be provided to the event listing engine by a front-end server (e.g., front-end server 110 of FIG. 1). Upon receipt of the request, the event listing engine identifies a user profile associated with the user that sent the request, and associates the identified user profile with the request, in block 230.

In block 240, the event listing engine determines an event listing including one or more events to present to the user. The event listing may be determined based on the user profile, including the media consumption history and/or the user preferences. Next, in block 250, the event listing engine also determines a playlist including one or more media files associated with the one or more events of the event listing. In one embodiment, the one or more media files of the playlist correspond to the artists associated with the events in the event listing. For example, if the event listing includes a listing of events relating to artists A, B, and C, then the associated playlist may include videos relating to artists A, B, and C. In addition, the playlist may be prioritized and ordered to include media files corresponding to the order of the event listing. In addition, relative media file popularity (e.g., number of views of the video, average percentage view-through, likes, favorites) may be taken into account in the selection process. According to another embodiment, a selection process may be employed wherein a score is assigned to each media element (e.g., video file, audio file) based on a user's viewing history and the preferences of other users having an overlapping viewing history. In addition, the selection process may consider artist's preferences wherein the media owner or media subject or representative specifies which media element they wish to be used when being promoted in a playlist. The media files may be stored in one or more databases connected to the event listing engine through, for example, network 102. For example, a video-sharing website/service and its associated databases may be communicatively connected to the event listing engine via the network 102. Media files available via the video sharing website may have been uploaded by various artists. The playlist may be created based on videos available via the video-sharing website, selected based on artist selection and user preferences and/or viewing history.

In one embodiment, in block 260, the event listing engine selects a media file from the playlist for playback. In one embodiment, the selected media file may be automatically played upon rendering an initial web page of the event ticket marketplace to the user, without any user action or initiation of the playback. For example, the selected media file may be a music video of an artist associated with the initial entry in the event listing.

Next, in block 270, the event listing engine generates a GUI presenting the event listing, the playlist, and the selected media file to the user. In one embodiment, the GUI is generated by the GUI generator 124 of the event listing engine 120 of FIG. 1. In one embodiment, the event listing engine generates a GUI including an event listing window for presenting the event listing, a media playlist window for presenting the playlist, and a media file playback window for presenting the selected media file. In one embodiment, following playback of the selected media file, a next entry in the playlist may be automatically played, and so on until the end of the playlist.

Following the initial generation of the GUI, the user's actions and/or interactions with the GUI may be considered by the event listing engine. For example, following a user action, the event listing engine may perform one or more of the actions in blocks 240-270, resulting in an updated GUI. The updated GUI may include an updated event listing, an updated playlist, and/or an updated selected media file. For example, if the user clicks on the third entry in the event listing related to Artist ABC, the event listing engine may perform the actions in blocks 240-270 to produce an event listing including events for Artist ABC, a playlist including the most viewed videos for Artist ABC, and an updated selected media file including a video featuring Artist ABC's most recent live performance.

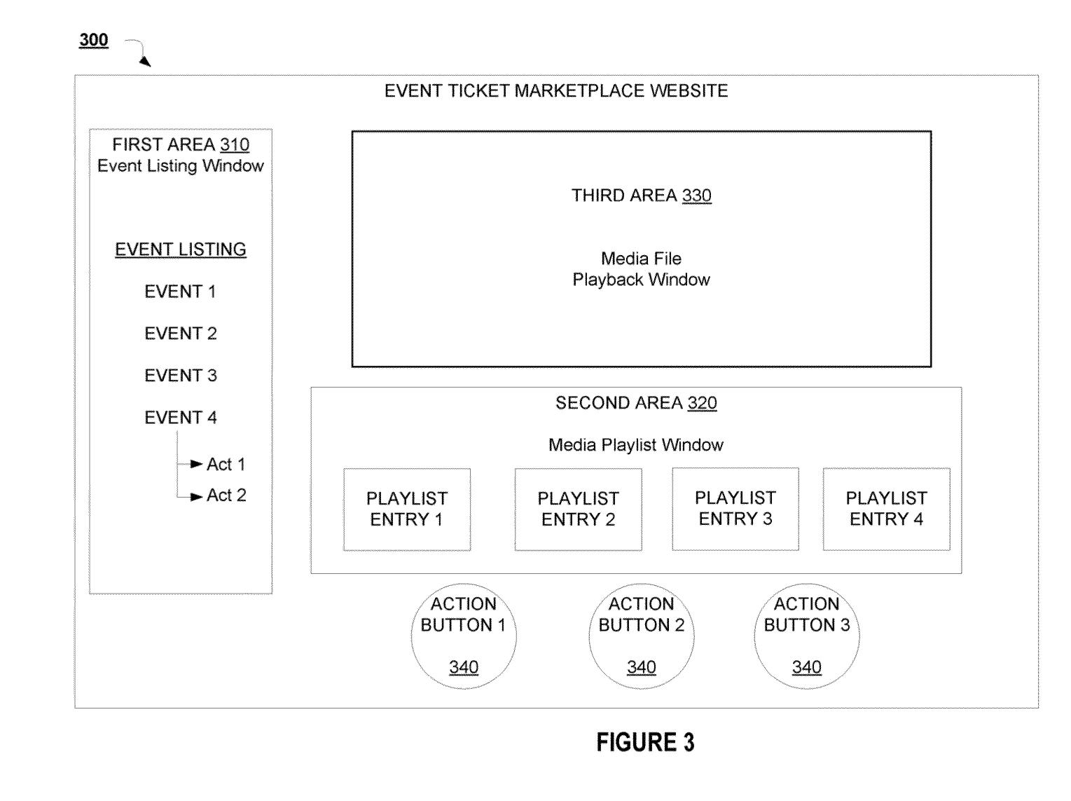

FIG. 3 illustrates an exemplary GUI 300 generated in accordance with method 200, described above with reference to FIG. 2. As shown, GUI 300 of the event ticket marketplace includes a first area 310, a second area 320, a third area 330, and action buttons 340 (e.g., Action Button 1, Action Button 2, and Action Button 3).

The first area 310, or event listing window, is configured to present the event listing generated by the event listing engine. The exemplary event listing includes information relating to four events (e.g., Event 1, Event 2, Event 3 and Event 4). As shown, exemplary Event 4 includes 2 acts which may have media files included in the playlist.

In the exemplary embodiment shown in FIG. 3, GUI 300 includes second area 320, or the media playlist window. In the second area 320, the entries of the playlist are presented. In the example shown, the playlist includes four playlist entries (e.g., Playlist Entry 1, Playlist Entry 2, Playlist Entry 3, and Playlist Entry 4). One having ordinary skill in the art will appreciate that the playlist entries may each represent an access point to a media file which may be selected by the user via a conventional website or application action (i.e., clicking on the playlist entry). In the event a user selects a playlist entry, the event listing engine retrieves the associated media file from the media information database 140, plays the retrieved media file in third area 330, and, optionally, updates the playlist and/or the event listing. In one embodiment, the playlist entries may be thumbnail or images associated with the underlying media file.

In the exemplary embodiment shown in FIG. 3, GUI 300 includes third area 330, or the media file playback window. In the third area 330, the selected media file is presented. In one embodiment, the selected media file automatically plays in the third area when the event ticket marketplace page is rendered to the user. In this regard, the selected media file automatically streams in the third area, without the need for any action by the user. As described above, the third area 330 may be updated and play an updated selected media file identified by the event listing engine in response to an interaction with the event listing, the playlist, or the initially selected media file.

In the exemplary embodiment shown in FIG. 3, GUI 300 includes one or more action buttons 340. The action buttons 340 represent certain actions the user may take by interacting with the action button. For example, GUI 300 may include an action button that allows the user to initiate a process for purchasing one or more tickets for an event in the event listing. One having ordinary skill in the art will appreciate that any number of action buttons may be provided which correspond to any suitable web-based actions.

One having ordinary skill in the art will further appreciate that there are many other possible arrangements, implementations and designs for GUI 300, and that GUI 300 may include additional fields, buttons, windows, etc. than those shown in the example illustrated in FIG. 3. One having ordinary skill in the art will appreciate that the generated GUI may have any number of arrangements, looks, feels, and styles.

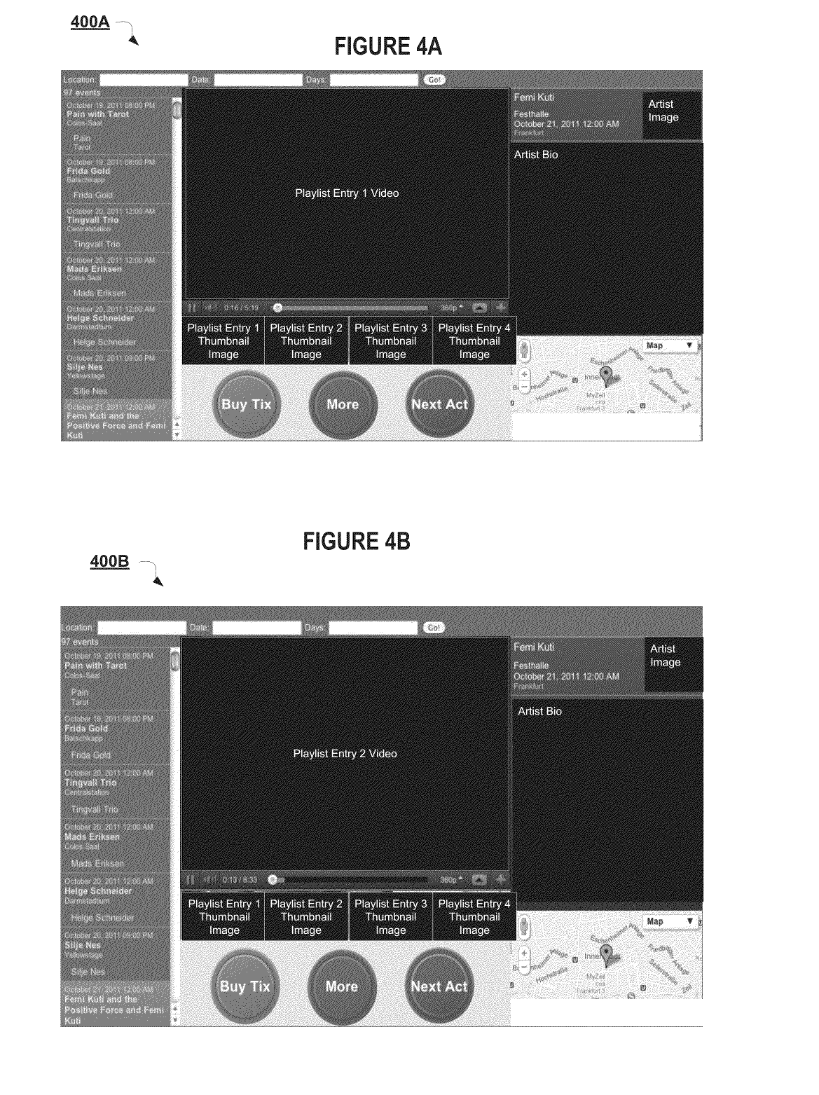

FIGS. 4A and 4B depict exemplary screenshots of an event ticket marketplace in accordance with embodiments of the present invention. As shown in FIG. 4A, following receipt of a request from a user, GUI 400A is generated. GUI 400A includes an event listing having ninety-seven events, a playlist including four playlist entries (i.e., Playlist Entry 1, Playlist Entry 2, Playlist Entry 3, and Playlist Entry 4), and a selected media file (e.g., a video relating to an artist named “Femi Kuti”). As shown in FIG. 4A, the selected media file corresponds with the highlighted event in the event list. In the embodiment illustrated in FIG. 4A, the Femi Kuti video (i.e., the “Playlist Entry 1 Video”) automatically begins playing after the GUI 400A is rendered on the user's device.

FIG. 4B illustrates a different video (i.e., the “Playlist Entry 2 Video”) playing in the media file playback window. The video also relates to Femi Kuti and is played back as a result of a user action (e.g., clicking on the corresponding image in the playlist) or following completion of the video corresponding to the first entry in the playlist (e.g., the video displayed in the media file playback window in FIG. 4A).

As shown in FIG. 4A and FIG. 4B, a “Buy Tix” action button, a “More” action button, and a “Next Act” action button are provided to the user. Additionally, GUIs 400A and 400B includes an area presenting information (e.g., a bio) regarding the artist associated with the selected media file (e.g., Femi Kuti). GUIs 400A and 400B also include an optional map indicating a location of the highlighted event.

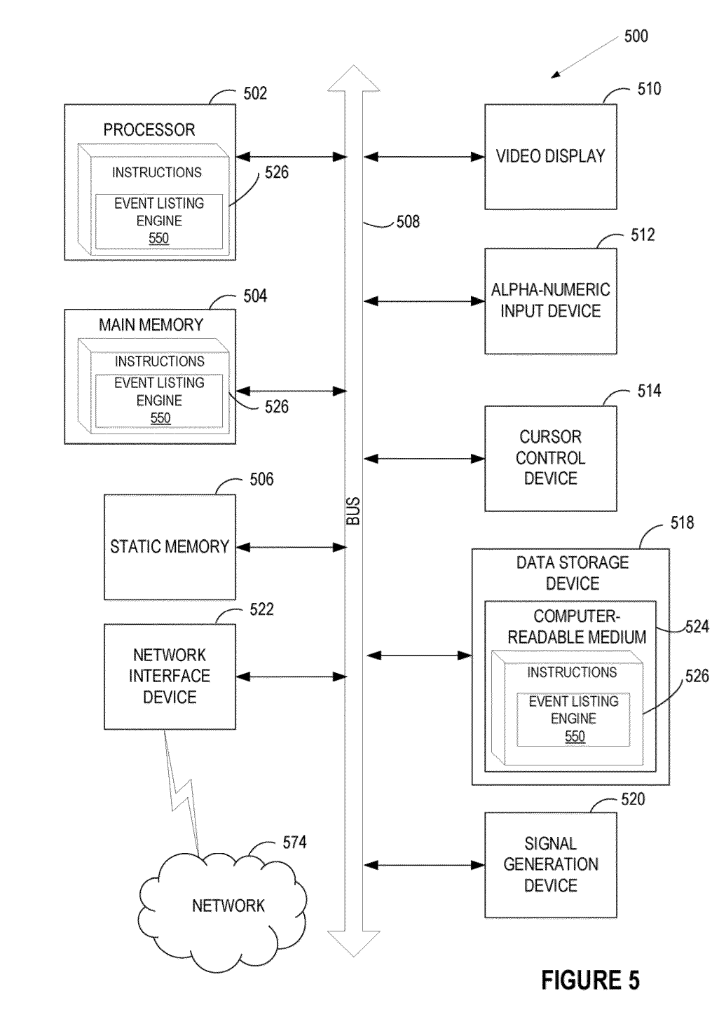

FIG. 5 illustrates a diagrammatic representation of a machine in the exemplary form of a computer system 500 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 518, which communicate with each other via a bus 508.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions 526 for performing the operations and steps discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 518 may include a computer-readable storage medium 524 on which is stored one or more sets of instructions 526 (e.g., software) embodying any one or more of the methodologies or functions described herein. The instructions 526 may also reside, completely or at least partially, within the main memory 504 and/or within the processor 502 during execution thereof by the computer system 500, the main memory 504 and the processor 502 also constituting computer-readable storage media. The instructions 526 may further be transmitted or received over a network 574 via the network interface device 522.

In one embodiment, the instructions 526 include instructions for an event listing engine 550, which may correspond to event listing engine 120 of FIG. 1, and/or a software library containing methods that call an object detection/recognition engine. While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical media, and magnetic media.

In the foregoing description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “identifying”, “receiving”, “responding”, “presenting”, “generating,” “streaming” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The word “exemplary” is used herein to mean serving as an example, instance, or illustration. For the avoidance of doubt, this matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Reference throughout this disclosure to “one implementation,” or “an implementation,” or “one embodiment,” or “an embodiment” means that a particular feature, structure, or characteristic described in connection with the implementation or embodiment is included in at least one implementation or one embodiment. Thus, the appearances of the phrase “in one implementation,” or “in an implementation,” or “in one embodiment,” or “in an embodiment” in various places throughout this specification can, but are not necessarily, referring to the same implementation or embodiment, depending on the circumstances. Furthermore, the particular features, structures, or characteristics may be combined in any suitable manner in one or more implementations or embodiments.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

1. A method for providing media relating to an event list, comprising:
receiving a request of a user for access to an event ticket marketplace; and
responding to the request by providing a graphical user interface (GUI), wherein providing the GUI comprises:
generating an event list comprising event information relating to events likely to be of interest to the user,
generating, based on the event list, a playlist comprising media files associated with the events,
causing a simultaneous presentation of the event information in a first area of the graphical user interface and the playlist in a second area of the graphical user interface, wherein the media files in the playlist presented in the second area of the graphical user interface are ordered according to an order of the associated events in the event list presented in the first area of the graphical user interface; and
enabling streaming of a first media file in the playlist in the graphical user interface, wherein the first media file from the playlist is to be played in a third area of the graphical user interface concurrently with the presentation of the event list in the first area of the graphical user interface and the ordered playlist including the first media file in the second area of the graphical user interface.

2. The method of claim 1, wherein the event list is generated based on a media consumption history associated with the user.

3. The method of claim 1, wherein enabling streaming of the first media file comprises enabling the first media file in the playlist to be automatically streamed in the third area of the GUI in response to the request.

4. The method of claim 1, wherein the request comprises a location of the user.

5. The method of claim 4, wherein the event list is based on the location of the user.

6. The method of claim 1, wherein the playlist is generated based at least in part on a user profile.

7. The method of claim 1 further comprising receiving a request of the user to purchase one or more tickets to at least one of the events.

8. The method of claim 1, wherein the first media file is selected based on a user profile.

9. The method of claim 1 further comprising:
receiving a positive indication relating to at least one of an event or a media file; and
updating, based on the positive indication, the playlist to include one or more additional media files associated with the event or the media file.

10. The method of claim 9, wherein the positive indication comprises at least one of pausing the media file, rewinding the media file, adjusting a volume of the media file, inputting a rating associated with the media file, repeating playback of the media file, or sharing a link to the media file.

11. The method of claim 1, wherein the event is generated based on a preference set by the user to exclude a previously viewed event from the event list.

12. A method for providing media relating to an event list, comprising:
receiving a request of a user for access to an event ticket marketplace; and
responding to the request by providing a graphical user interface (GUI), wherein providing the GUI comprises:
generating an event list comprising event information relating to suggested events selected for the user based on a media consumption history of the user,
generating, based on the event list, a playlist comprising media files associated with the suggested events,
causing a simultaneous presentation of the event information in a first area of the GUI and the playlist in a second area of the GUI, wherein the media files in the playlist presented in the second area of the graphical user interface are ordered according to an order of the associated events in the event list presented in the first area of the graphical user interface, and
enabling streaming of a first media file in the playlist in the GUI, wherein the first media file from the playlist is to be played in a third area of the GUI concurrently with the presentation of the event list in the first area of the graphical user interface and the ordered playlist including the first media file in the second area of the graphical user interface.

13. The method of claim 12, wherein enabling streaming of the first media file comprises enabling the first media file to be automatically streamed in a third area of the GUI upon rendering of the GUI.

14. The method of claim 12 further comprising:
receiving a positive indication relating to at least one of an event or a media file; and
updating, based on the positive indication, the playlist to include one or more additional media files associated with the event or the media file.

15. A computing device comprising:
a memory; and
a processing device coupled to the memory, wherein the processing device is configured to:
receive, from a user, a request for access to an event ticket marketplace, and
respond to the request by presenting a graphical user interface (GUI), wherein presenting the GUI comprises:
receiving an event list comprising event information relating to events likely to be of interest to the user, wherein the event list is likely to be of interest to the user,
receiving a playlist comprising media files associated with the events,
simultaneously rendering the event information in a first area of the GUI and the playlist in a second area of the GUI, wherein the media files in the playlist presented in the second area of the graphical user interface are ordered according to an order of the associated events in the event list presented in the first area of the graphical user interface, and
streaming a first media file in the playlist in a third area of the GUI, wherein the first media file from the playlist is to be played in the third area of the GUI concurrently with the presentation of the event list in the first area of the graphical user interface and the ordered playlist including the first media file in the second area of the graphical user interface.

16. The computing device of claim 15, wherein the event list is based on a media consumption history associated with the user.

17. The computing device of claim 15, further comprising a locator component, wherein the locator component determines a location of the computing device, and wherein the event list is based on the location.

18. (canceled)

19. The computing device of claim 17, wherein the computing device is a mobile device.

20. The computing device of claim 15, wherein the processing device is further configured to receive a positive indication relating to at least one of an event or a media file; and update, based on the positive indication, the playlist to include one or more additional media files associated with the event or the media file.

21. The computing device of claim 15, wherein streaming the first media file comprises automatically streaming the first media file in the third area of the GUI upon rendering of the GUI.
